(19) United States
(12) Patent Application Publication
(10) Pub. No.: US 2007/0028944 A1
(43) Pub. Date: Feb. 8, 2007

(54) Method of using NF3 for removing surface deposits

(76) Inventors: Herbert H. Sawin, Chestnut Hill, MA (US); Bo Bai, Cambridge, MA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/497,762

(22) Filed: Aug. 2, 2006

Related U.S. Application Data
(60) Provisional application No. 60/704,840, filed on Aug. 2, 2005.

(51) Int. Cl. B08B 9/00; B08B 6/00

(52) U.S. Cl. 134/1.1; 134/22.1

(57) ABSTRACT

The present invention relates to an improved remote plasma cleaning method for removing surface deposits from a surface, such as the interior of a process chamber that is used in fabricating electronic devices. The improvement involves using an activated gas with high neutral temperature of at least about 3000 K, and addition of an oxygen source to the NF₃ cleaning gas mixture to improve the etching rate.

### BACKGROUND OF THE INVENTION

1. Field of the Invention

The present invention relates to methods for removing surface deposits by using an activated gas mixture created by remotely activating a gas mixture comprising an oxygen source and NF₃. More specifically, this invention relates to methods for removing surface deposits from the interior of a chemical vapor deposition chamber by using an activated gas mixture created by remotely activating a gas mixture comprising an oxygen source and NF₃.

2. Description of Related Art

The Chemical Vapor Deposition (CVD) chambers and Plasma Enhanced Chemical Vapor Deposition (PECVD) chambers in the semiconductor processing industry require regular cleaning. Popular cleaning methods include in-situ plasma cleaning and remote chamber plasma cleaning.

In the in-situ plasma cleaning process, the cleaning gas mixture is activated to plasma within the CVD/PECVD process chamber and cleans the deposits in-situ. In-situ plasma cleaning method suffers from several deficiencies. First, chamber parts not directly exposed to the plasma can not be cleaned. Second, the cleaning process includes ion bombardment-induced reactions and spontaneous chemical reactions. Because the ion bombardment sputtering erodes the surfaces of chamber parts, expensive and time-consuming parts replacement is required.

Realizing the disadvantages of in-situ plasma cleaning, the remote chamber plasma cleaning methods are becoming more popular. In remote chamber plasma cleaning process, the cleaning gas mixture is activated by a plasma in a separate chamber other than the CVD/PECVD process chamber. The plasma neutral products then pass from the source chamber to the interior of the CVD/PECVD process chamber. The transport passage may, for example, consists of a short connecting tube and the showerhead of the CVD/PECVD process chamber. In contrast to in-situ plasma cleaning methods, remote chamber plasma cleaning process involves only spontaneous chemical reactions, and thus avoids erosion problems caused by ion bombardment in the process chamber.

While capacitively and inductively coupled radio frequency (RF) as well as microwave remote sources have been developed as power sources for the remote chamber plasma cleaning process, the industry is rapidly moving toward transformer coupled inductively coupled sources in which the plasma has a torroidal configuration and acts as the secondary of the transformer. The use of lower frequency RF power allows the use of magnetic cores which enhance the inductive coupling with respect to capacitive coupling; thereby allowing the more efficient transfer of energy to the plasma without excessive ion bombardment which limits the lifetime of the remote plasma source chamber interior.

NF₃, fluorocarbons, SF₆, et al. have been used as cleaning gases in the plasma cleaning process. Among these, NF₃ is particularly attractive due to its relatively weak nitrogen-fluorine bond. NF₃ dissociates readily and does not generate green-house gas emmission. There is a need to use NF₃ effectively as a cleaning gas.

### BRIEF SUMMARY OF THE INVENTION

The present invention relates to a method for removing surface deposits, said method comprising: (a) activating in a remote chamber a gas mixture comprising an oxygen source and NF₃ using sufficient power for a sufficient time such that said gas mixture reaches a neutral temperature of at least about 3,000 K to form an activated gas mixture, and thereafter (b) contacting said activated gas mixture with the surface deposits and thereby removing at least some of said surface deposits.

### BRIEF DESCRIPTION OF THE DRAWING(S)

FIG. 1. Schematic diagram of an apparatus useful for carrying out the present process.

FIG. 2. Plot of the effect to etching rates on silicon nitride with O₂ addition to NF₃+Ar feeding gas mixture.

FIG. 3. Plot of the effect to etching rates on silicon dioxide with O₂ addition to NF₃+Ar feeding gas mixture.

### DETAILED DESCRIPTION OF THE INVENTION

Surface deposits removed with this invention comprise those materials commonly deposited by chemical vapor deposition or plasma-enhanced chemical vapor deposition or similar processes. Such materials include silicon, doped silicon, silicon nitride, tungsten, silicon dioxide, silicon oxynitride, silicon carbide, SiBN and various silicon oxygen compounds referred to as low K materials, such as FSG (fluorosilicate glass), silicon carbides and SiCₓOₓHₓ or PECVD OSG including Black Diamond (Applied Materials), Coral (Novellus Systems) and Aurora (ASM International). Preferred surface deposit in this invention is silicon nitride.

One embodiment of this invention is removing surface deposits from the interior of a process chamber that is used in fabricating electronic devices. Such a process chamber could be a Chemical Vapor Deposition (CVD) chamber or a Plasma Enhanced Chemical Vapor Deposition (PECVD) chamber.

Other embodiments of this invention include, but are not limited to, removing surface deposits from metals, the cleaning of plasma etching chambers and the stripping of photoresists.

The process of the present invention involves an activating step wherein a cleaning gas mixture will be activated in a remote chamber. Activation may be accomplished by any means allowing for the achievement of dissociation of a large fraction of the feed gas, such as: radio frequency (RF) energy, direct current (DC) energy, laser illumination and microwave energy. One embodiment of this invention is using transformer coupled inductively coupled lower frequency RF power sources in which the plasma has a torroidal configuration and acts as the secondary of the transformer. The use of lower frequency RF power allows the use of magnetic cores that enhance the inductive coupling with respect to capacitive coupling; thereby allowing the more efficient transfer of energy to the plasma without excessive ion bombardment which limits the lifetime of the remote plasma source chamber interior. Typical RF power used in this invention has frequency lower than 1,000 KHz. Another embodiment of the power source in this invention is a remote microwave, inductively, or capacitively coupled plasma source.

Activation in the present invention uses sufficient power for a sufficient time to form an activated gas mixture having neutral temperature of at least about 3,000 K. The neutral temperature of the resulting plasma depends on the power and the residence time of the gas mixture in the remote chamber. Under certain power input and conditions, neutral temperature will be higher with longer residence time. In this invention, the preferred neutral temperature of activated gas mixture is over about 3,000 K. Under appropriate conditions (considering power, gas composition, gas pressure and gas residence time), neutral temperatures of at least about 6000 K may be achieved.

The activated gas is formed in a separate, remote chamber that is outside of the process chamber, but in close proximity to the process chamber. In the invention, remote chamber refers to the chamber wherein the plasma is generated, and process chamber refers to the chamber wherein the surface deposits are located. The remote chamber is connected to the process chamber by any means allowing for transfer of the activated gas from the remote chamber to the process chamber. For example, the transport passage may consist of a short connecting tube and a showerhead of the CVD/PECVD process chamber. The remote chamber and means for connecting the remote chamber with the process chamber are constructed of materials known in this field to be capable of containing activated gas mixtures. For instance, aluminum and anodized aluminum are commonly used for the chamber components. Sometimes Al₂O₃ is coated on the interior surface to reduce the surface recombination.

The gas mixture that is activated to form the activated gas comprises an oxygen source and NF₃. An “oxygen source” of the invention is herein referred to as a gas which can generate atomic oxygen in the activating step in this invention. Examples of an oxygen source here include, but are not limited to O₂ and nitrogen oxides. Nitrogen oxides of the invention is herein referred to as molecules consisting of nitrogen and oxygen. Examples of nitrogen oxides include, but are not limited to NO, N₂O, NO₂. Preferred oxygen source is oxygen gas.

The gas mixture that is activated to form the activated gas may further comprise a carrier gas such as argon, nitrogen and helium.

The total pressure in the remote chamber during the activating step may be between about 0.1 Torr and about 20 Torr.

It was found that an oxygen source can dramatically increase the etching rate of NF₃ on silicon nitrides. In one embodiment as shown in Example 1 below, a small amount of oxygen gas addition can increase the NF₃/Ar cleaning gas mixture etching rate on silicon nitride by four-fold.

The following Examples are meant to illustrate the invention and are not meant to be limiting.

### EXAMPLES

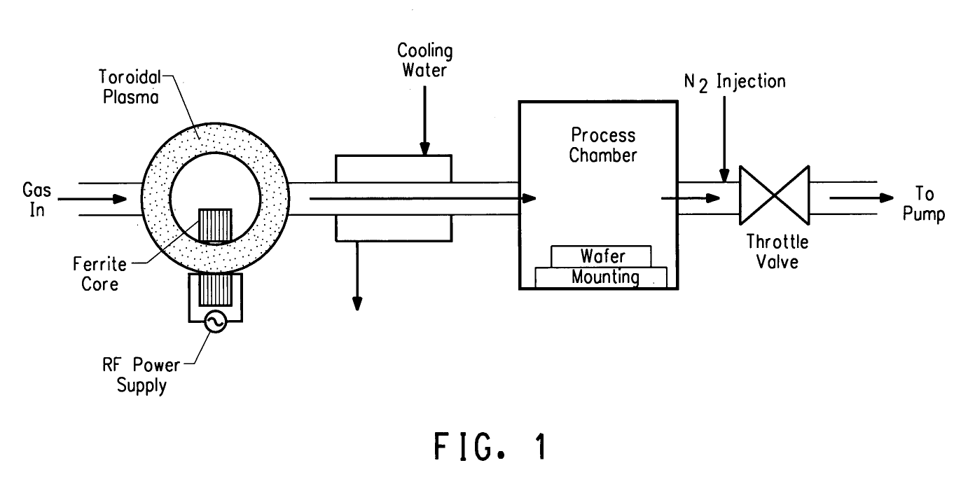

FIG. 1 shows a schematic diagram of the remote plasma source, transportation tube, process chamber and exhaust emission apparatus used in this invention. The remote plasma source is a commercial toroidal-type MKS ASTRON®ex reactive gas generator unit made by MKS Instruments, Andover, Mass., USA. The feed gases (e.g. oxygen, NF₃, Argon) were introduced into the remote plasma source from the left, and passed through the toroidal discharge where they were discharged by the 400 KHz radio-frequency power to form an activated gas mixture. The oxygen is manufactured by Airgas with 99.999% purity. The NF₃ gas is manufactured by DuPont with 99.999% purity. Argon is manufactured by Airgas with grade of 5.0. The activated gas mixture then passed through an aluminum water-cooled heat exchanger to reduce the thermal loading of the aluminum process chamber. The surface deposits covered wafer was placed on a temperature controlled mounting in the process chamber. The neutral temperature is measured by Optical Emission Spectroscopy (OES), in which rovibrational transition bands of diatomic species like C₂ and N₂ are theoretically fitted to yield neutral temperature. See also B. Bai and H. Sawin, Journal of Vacuum Science & Technology A 22 (5), 2014 (2004), herein incorporated as a reference. The etching rate of the surface deposits by the activated gas is measured by interferometry equipment in the process chamber. N₂ gas is added at the entrance of the exhaustion pump both to dilute the products to a proper concentration for FTIR measurement and to reduce the hang-up of products in the pump. FTIR was used to measure the concentration of species in the pump exhaust.

### Example 1

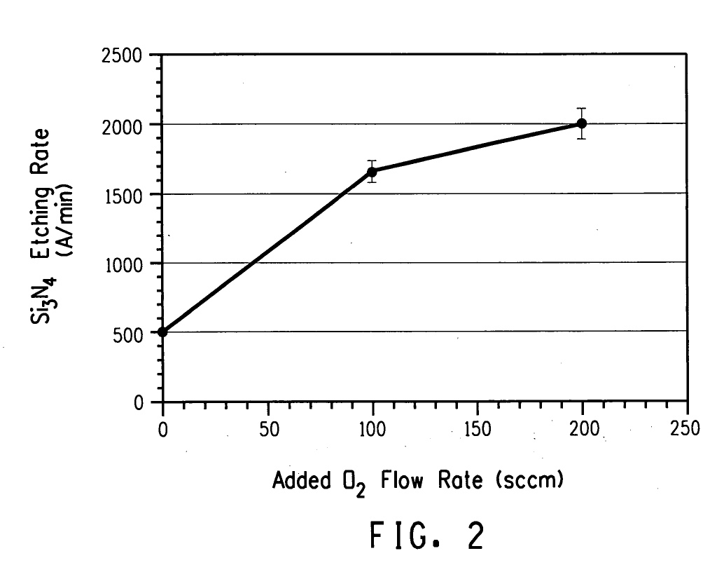

This Example demonstrated the effect of oxygen source addition on the silicon nitride etching rate of NF₃/Ar systems. The results are also shown in FIG. 2. In this experiment, the feeding gas composed of NF₃, Ar and optionally O₂, wherein NF₃ flow rate was 1333 sccm, Ar flow rate was 2667 sccm. Chamber pressure was 2 torr. The feeding gas was activated by the 400 KHz 4.6 Kw RF power to a neutral temperature more than 3000 K. The activated gas then entered the process chamber and etched the silicon nitride surface deposits on the mounting with the temperature controlled at 50° C. When there was no oxygen source in the feeding gas mixture, i.e. the feeding gas mixture was composed of 1333 sccm NF₃ and 2667 sccm Ar, the etching rate was only 500 Å/min. As shown in FIG. 2, when 100 sccm O₂ was added in the feeding gas mixture, i.e. the feeding gas mixture was composed of 100 sccm O₂, 1333 sccm NF₃ and 2667 sccm Ar, the etching rate of silicon nitride was increased from 500 to 1650 Å/min. If 200 sccm O₂ was added in the feeding gas mixture, i.e. the feeding gas mixture was composed of 200 sccm O₂, 1333 sccm NF₃ and 2667 sccm Ar, the etching rate was further increased to 2000 Å/min.

### Example 2

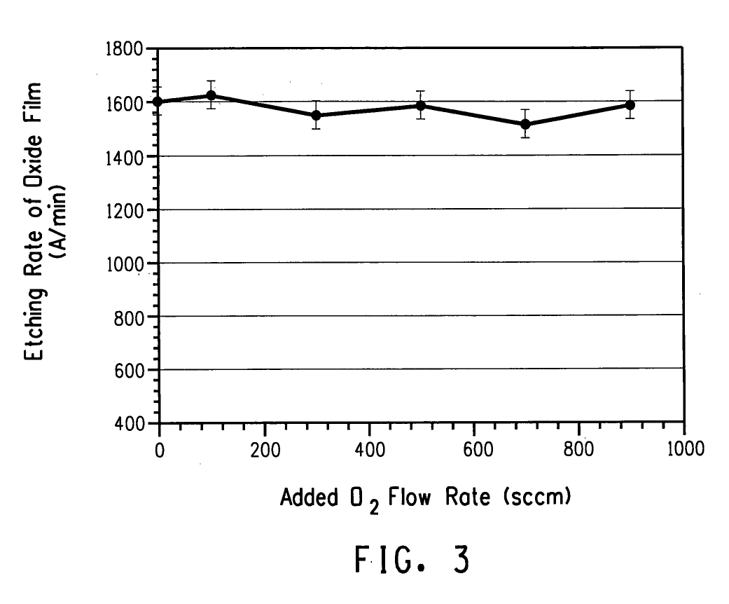

This Example showed the silicon dioxide etching rate of NF₃/O₂/Ar systems. The NF₃ flow rate was controlled at 1333 sccm, the Ar flow rate was 2667 sccm, the O₂ flow rate was 0, 100, 300, 500, 700, 900 sccm respectively. It was found that oxygen addition had no significant impact on the silicon dioxide etching rate of NF₃/Ar systems. In this experiment, chamber pressure was 2 torr. The feeding gas was activated by the 400 KHz 4.6 Kw RF power to a neutral temperature more than 3000 K. The activated gas then entered the process chamber and etched the silicon dioxide surface deposits on the mounting with the temperature controlled at 100° C. The etching rate was shown in FIG. 3.

What is claimed is:

1. A method for removing surface deposits, said method comprising:
(a) activating in a remote chamber a gas mixture comprising an oxygen source and NF₃ using sufficient power for a sufficient time such that said gas mixture reaches a neutral temperature of at least about 3,000 K to form an activated gas mixture, and thereafter
(b) contacting said activated gas mixture with the surface deposits and thereby removing at least some of said surface deposits.

2. The method of claim 1, wherein said surface deposits is removed from the interior of a process chamber that is used in fabricating electronic devices.

3. The method of claim 1, wherein said oxygen source is oxygen gas or nitrogen oxides.

4. The method of claim 3, wherein said oxygen source is oxygen gas.

5. The method of claim 1, wherein the surface deposit is selected from a group consisting of silicon, doped silicon, silicon nitride, tungsten, silicon dioxide, silicon oxynitride, silicon carbide and various silicon oxygen compounds referred to as low K materials.

6. The method of claim 5, wherein the surface deposit is silicon nitride.

7. The method of claim 1, wherein said power is generated by a RF source, a DC source or a microwave source.

8. The method of claim 7, wherein said power is generated by a RF source.

9. The method of claim 8, wherein said activated gas mixture in the remote chamber forms a torroidal configuration and said RF power is transformer coupled inductively coupled having frequency lower than 1,000 KHz.

10. The method of claim 9, wherein at least one magnetic core is used to enhance said inductive coupling.

11. The method of claim 1, wherein the pressure in the remote chamber is between 0.1 Torr and 20 Torr.

12. The method of claim 1, wherein said gas mixture further comprises a carrier gas.

13. The method of claim 12, wherein said carrier gas is at least one gas selected from the group of gases consisting of nitrogen, argon and helium.

14. The method of claim 13, wherein said carrier gas is argon, helium or their mixture.
